(19) United States
(12) Patent Application Publication
(10) Pub. No.: US 2026/0004416 A1
(43) Pub. Date: Jan. 1, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: SHINICHI MITSUMOTO, Saitama (JP)

(21) Appl. No.: 19/245,014

(22) Filed: Jun. 20, 2025

(30) Foreign Application Priority Data
Jun. 26, 2024 (JP) 2024-102843

(51) Int. Cl. G06T 7/00; G01N 21/88; G06Q 10/0631; G06V 10/20; G06V 20/10

(52) U.S. Cl. CPC G06T 7/0006; G01N 21/8851; G06Q 10/063112; G06V 10/255; G06V 20/176; G01N 2021/8887

(57) ABSTRACT

An information processing apparatus includes one or more memories storing instructions and one or more processors. The one or more processors are configured to, upon executing the instructions, detect, as a candidate region, a region within a predetermined size range including two or more end points of distresses from a captured image of an inspection target, acquire a difficulty in a case where a user determines whether to perform a predetermined task on the distresses having the end points included in the candidate region, and display the candidate region based on the difficulty.

### BACKGROUND

### Field

The present disclosure relates to an information processing technique for presenting distress in structures and the like to a user.

### Description of the Related Art

There has been a technique in which a computer device uses machine leaning on images of inspection targets, such as walls of concrete structures, to detect distresses (e.g., cracks) and to detect attributes of the distresses, such as crack width, through image analysis. In doing so, a false detection or a missed detection of distresses may occur in some parts of the captured images due to partial image quality degradation, such as motion blur and defocus in imaging. Thus, a user may check the positions where distresses, such as cracks, are detected in the images, and correct or edit the distress data based on results of the check. Japanese Patent Application Laid-Open No. 2020-56303 discloses a technique for calculating a crack rate by diving the captured images into predetermined rectangles and determining whether cracks have been detected in the divided rectangles.

According to the conventional technique, the user needs to check the images and determine whether individual distresses require correction or editing. This can be a very burdensome and difficult task for the user.

### SUMMARY

The present disclosure is directed to a technique for presenting positions of the distresses that require correction and editing to the user.

According to an aspect of the present disclosure, an information processing apparatus includes one or more memories storing instructions and one or more processors. The one or more processors are configured to, upon executing the instructions, detect, as a candidate region, a region within a predetermined size range including two or more end points of distresses from a captured image of an inspection target, acquire a difficulty in a case where a user determines whether to perform a predetermined task on the distresses having the end points included in the candidate region, and display the candidate region based on the difficulty.

Further features of various embodiments will become apparent from the following description of exemplary embodiments with reference to the attached drawings.

### BRIEF DESCRIPTION OF THE DRAWINGS

FIG. 1 is a block diagram illustrating a hardware configuration example of an information processing apparatus.

FIG. 2 is a table illustrating an example of a distress data table.

FIG. 3 is a diagram illustrating a display example of cracks drawn based on distress data.

FIGS. 4A and 4B are diagrams each illustrating an example of a graphical user interface (GUI) screen for a distress check according to a first exemplary embodiment.

FIG. 5 is a flowchart of check candidate presentation processing.

FIG. 6 is a diagram illustrating a check candidate region.

FIG. 7 is a diagram illustrating an example of a rule setting screen.

FIG. 8 is a diagram illustrating an example of a check candidate region table.

FIGS. 9A to 9C are diagrams each illustrating an example of a GUI screen for a distress check according to a second exemplary embodiment.

FIG. 10 is a diagram illustrating an example of a GUI screen for a distress check according to a third exemplary embodiment.

### DESCRIPTION OF THE EMBODIMENTS

Some exemplary embodiments according to the present disclosure will be described below with reference to drawings. The following exemplary embodiments do not limit every embodiment of the present disclosure. All of combinations of features described in the exemplary embodiments are not necessarily essential for solving means of the present disclosure, and a plurality of features may be desirably combined. Configurations according to the exemplary embodiments can be appropriately corrected or changed depending on specifications of an apparatus to which the present disclosure is applied, and various kinds of conditions (e.g., use condition and use environment). In the following exemplary embodiments, like reference numerals refer to like components, and the redundant description will be omitted.

A first exemplary embodiment will now be described. In the present exemplary embodiment, an example will be described where a plurality of distresses is detected from a captured image of an inspection target which is a concrete structure, such as various roads including an expressway, a bridge, a tunnel, and a dam, and the user performs correction and editing with respect to the distresses. Further, in the present exemplary embodiment, an example will be described of cracks in a concrete surface due to damage, deterioration, or other factors as detected distresses from the captured image of the inspection target. A crack refers to linear damage with a starting point, an end point, a length, and a width, which occurs to walls and the like of concrete structures due to deterioration over time, seismic impacts, and other causes.

In the present exemplary embodiment, as correction and editing (hereinafter, referred to as correction) performed by the user on crack distresses detected from the captured image of the inspection target, for example, an example will be described of connecting cracks with the end points close to each other on the image to form a single crack. For example, if there are cracks with the end points close to each other on the image, the user determines (checks) whether those end points are actually connected as a single crack. If determining that the cracks should be connected, the user performs correction so as to connect the close end points of the cracks. However, identifying all cracks with the end points close to each other among a plurality of cracks in the image is a burdensome task for the user, and some cracks may be missed. Further, even if the user can identify cracks with the end points close to each other, determining whether to perform correction to connect the end points of the cracks is also a difficult task for the user. Especially, when end points of three or more cracks are close to each other, it is extremely difficult for the user to determine which of end points among the plurality of cracks are to be connected.

Thus, in an information processing apparatus according to the present exemplary embodiment, based on detection results of predetermined distresses (cracks) obtained from the captured image of the inspection target, regions within a predetermined size range that have two or more end points of the predetermined distresses are detected as check candidate regions where the user should perform the predetermined corrections. Further, the information processing apparatus according to the present exemplary embodiment acquires a difficulty level (referred to as a check difficulty) for the user to determine whether to perform the predetermined task on distresses with the end points included in the check candidate regions.

The information processing apparatus highlights the check candidate regions based on the check difficulties acquired for the individual check candidate regions. Details of processing for detecting distresses from a captured image of an inspection target, detecting check candidate regions, acquiring a check difficulty, and highlighting the check candidate regions based on the check difficulties will be described below.

### Hardware Configuration

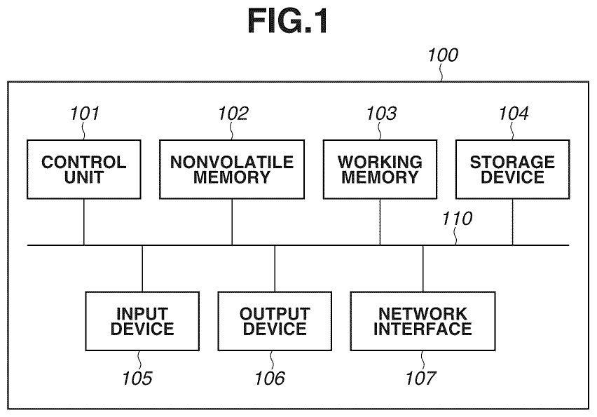

FIG. 1 is a block diagram illustrating a hardware configuration example that can implement an information processing apparatus 100 according to the present exemplary embodiment. In the present exemplary embodiment, an example where a computer apparatus operates as the information processing apparatus 100 will be described. Information processing according to the present exemplary embodiment can be performed by a single computer apparatus, or can be performed by distributing respective functions across a plurality of computer apparatuses as necessary. When the functions are distributed among the plurality of computer apparatuses, the plurality of computer apparatuses is communicably connected to each other.

The information processing apparatus 100 includes a control unit 101, a nonvolatile memory 102, a working memory 103, a storage device 104, an input device 105, an output device 106, a network interface 107, and a system bus 110.

The control unit 101 includes calculation processing processors, such as a central processing unit (CPU) and a microprocessor unit (MPU), both of which generally control the information processing apparatus 100. The nonvolatile memory 102 is a read-only memory (ROM) storing programs to be executed by the processors of the control unit 101, and parameters. The programs stored in the nonvolatile memory 102 include an operating system (OS) that is basic software to be executed by the control unit 101, and application programs that carry out applicable functions in cooperation with the OS. An information processing program according to the present exemplary embodiment is stored as one of the application programs in the nonvolatile memory 102. The control unit 101 reads the information processing program and execute the program to perform check candidate presentation processing as described below. The application programs include programs for using basic functions of the OS.

In addition, the OS itself may include the information processing program according to the present exemplary embodiment. The information processing program according to the present exemplary embodiment may be stored in the nonvolatile memory 102, as well as in the storage device 104.

The working memory 103 is a random-access memory (RAM) that temporarily stores programs and data supplied from the nonvolatile memory 102, the storage device 104, an external device, and the like. The storage device 104 is an internal device, such as a hard disk and a memory card, incorporated in the information processing apparatus 100, or an external device, such as a hard disk and a memory card, detachably connected to the information processing apparatus 100. In the present exemplary embodiment, the storage device 104 stores a distress data table in which a plurality of pieces of distress data detected from the captured image of the inspection target is registered. Details of the distress data table will be described below. The storage device 104 may include a memory card including a semiconductor memory, and a hard disk including a magnetic disk and the like. The storage device 104 may also include a storage medium including a disk drive that reads/writes data from/to an optical disk, such as a digital versatile disk (DVD) and Blu-ray Disc®.

The input device 105 includes operation devices, such as a mouse, a keyboard, and a touch panel for receiving input operations from the user, and outputs the operation instructions input by the user to the control unit 101. The output device 106 includes a display device, such as a display and a monitor including a liquid crystal display (LCD) and an organic electroluminescence (EL). The control unit 101 generates display data based on data stored in the information apparatus 100 and data supplied from an external device, and display data for a graphical user interface (GUI) screen described below, and transmits those pieces of display data to the output device 106. The network interface 107 communicates with a network, such as the Internet and a local area network (LAN).

The system bus 110 connects the components (e.g., from the control unit 101 to the network interface 107) of the information processing apparatus 100, and enables mutual data exchange between the components. The system bus 110 includes an address bus, a data bus, and a control bus.

### Distress Data Table

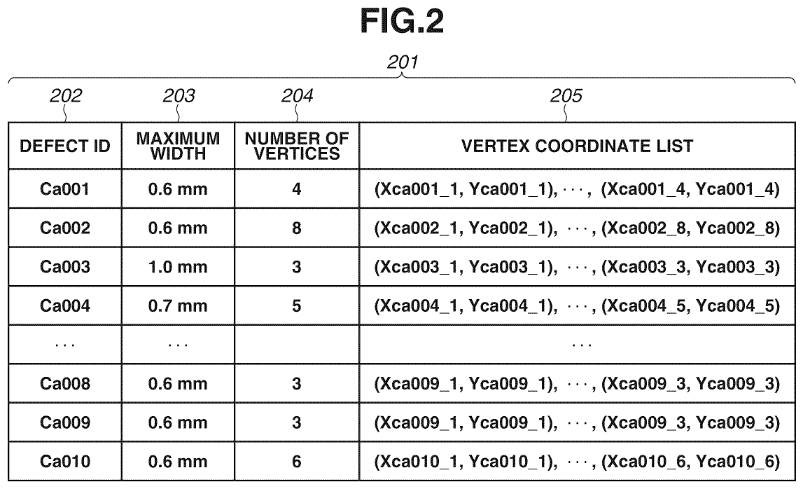

FIG. 2 is a table illustrating a data structure example of the distress data table in which a plurality of pieces of distress data detected from the captured image of the inspection target is registered. In the present exemplary embodiment, the distress data table is a table in which distress data corresponding to a plurality of distresses detected from the captured image of the inspection target, such as a concrete structure, is registered. The distress data table is generated by registering distress data automatically generated from the captured image using image analysis processing and the like, distress data generated from traced information about distresses on the captured image by the user, or distress data generated by combining those. As the image analysis processing for automatically generating distress data from a captured image, for example, processing using a trained model created by machine learning or deep learning of artificial intelligence (AI) can be used. A distress data table is generated for each inspection target, and the distress data table generated for each inspection target is stored in, for example, the storage device 104. In the present exemplary embodiment, the processing of detecting distresses from a captured image of the inspection target, and the processing of registering distress data corresponding to the plurality of detected distresses in a distress data table are previously performed by the information processing apparatus 100. The processing of detecting distresses from a captured image of the inspection target, and the processing of registering distress data corresponding to the plurality of detected distresses in a distress data table can be performed by a computer apparatus or the like other than the information processing apparatus 100.

A distress data table 201 illustrated in FIG. 2 is a table in which, for example, distress data on cracks is registered. The distress data on cracks includes a defect identification (ID) 202, a maximum width 203, the number of vertices 204, and a vertex coordinate list 205.

The defect ID 202 is identification information uniquely assigned to each crack. The maximum width 203 is a maximum value of a width (thickness) of the corresponding crack. The number of vertices 204 corresponds to a starting point and an end point of each line segment when the shape of a crack is represented as a polyline consisting of one or more line segments. The vertex coordinate list 205 is information on coordinates of vertices corresponding to a starting point and an end point of each line segment when the shape of a crack is represented as a polyline consisting of one or more line segments. The coordinates of each of the vertices in the vertex coordinate list 205 are coordinates in a coordinate space corresponding to the captured image.

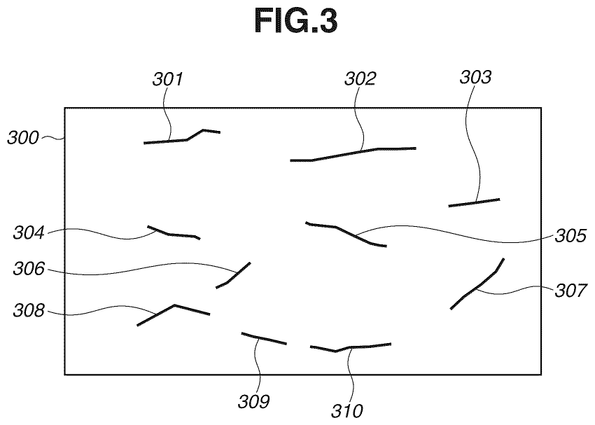

FIG. 3 is a diagram illustrating an example of a display screen 300 that displays cracks drawn based on the distress data registered in the distress data table 201 illustrated in FIG. 2. In the display screen 300, for example, a crack 301 is an image example of a crack drawn based on the distress data having the defect ID of Ca001 in the distress data table 201. Similarly, cracks 302 to 310 are image examples of cracks drawn based on the distress data having the defect IDs of Ca002 to Ca010.

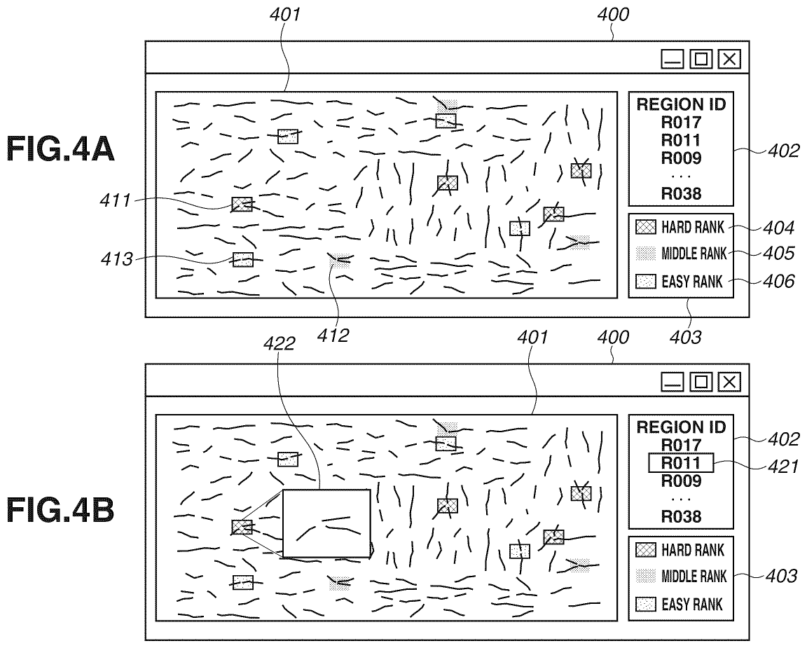

FIG. 4A is a diagram illustrating an example of a distress check GUI screen 400 displayed on the output device 106 when the control unit 101 executes a program of the check candidate presentation processing.

The control unit 101 acquires the distress data from the distress data table 201, and displays the GUI screen 400 as illustrated in FIG. 4A on the output device 106 based on the distress data.

The GUI screen 400 includes a result display region 401, a check region list 402, and a candidate legend display region 403.

The result display region 401 displays crack images drawn based on the distress data, and check candidate regions. The check region list 402 displays region IDs of the respective check candidate regions in a list form.

The candidate legend display region 403 displays legends that indicate check difficulties for the user to check (determine) whether individual crack distresses require correction. In FIG. 4A, three legends of a hard rank 404, a middle rank 405, and an easy rank 406 are illustrated as the legends of check difficulties. In FIGS. 4A and 4B, in the candidate legend display region 403, the characters “hard rank” and a hard rank highlight image indicating the hard rank 404, the characters “middle rank” and a middle rank highlight image indicating the middle rank 405, and the characters “easy rank” and an easy rank highlight image indicating the easy rank 406 are displayed. The hard rank 404 indicates that regions are high in check difficulty, where determination of correction necessary for the corresponding cracks is extremely difficult for the user. The middle rank 405 indicates that the check difficulty of making a judgement by the user is lower than the hard rank and higher than the easy rank. The easy rank 406 indicates regions where the check difficulty for the user is low. The control unit 101 calculates a score of the check difficulty for each of the check candidate regions in a manner described below, and displays a translucent highlight image superimposed on each of the check candidate regions in the result display region 401 based on the score of the check difficulty. In FIGS. 4A and 4B, in the result display region 401, the hard rank highlight image indicating the hard rank 404 is superimposed on a check candidate region 411, the middle rank highlight image indicating the middle rank 405 is superimposed on a check candidate region 412, and the easy rank highlight image indicating the easy rank 406 is superimposed on a check candidate region 413. In FIGS. 4A and 4B, as examples of the highlight images indicating the hard rank, the middle rank, and the easy rank, a lattice pattern and a dot pattern are used. However, the highlight images are not limited thereto, and for example, different colors, different luminance, and different marks may be used.

### Check Candidate Presentation Processing

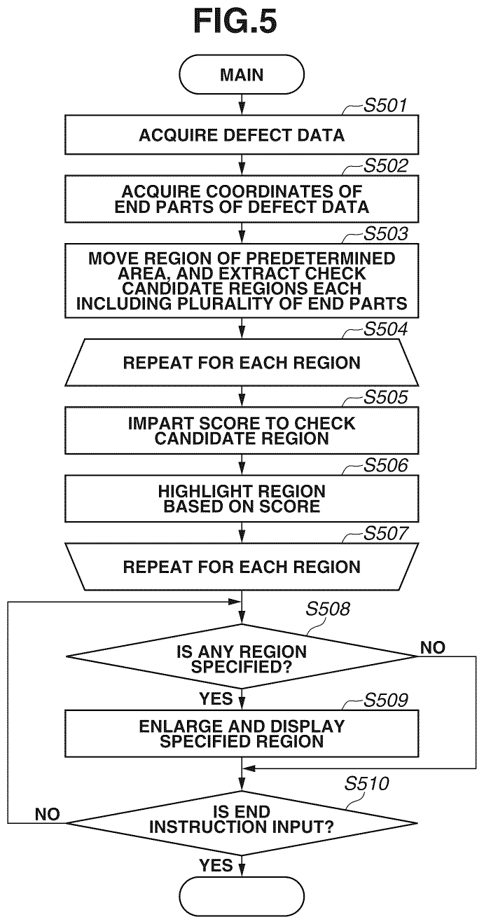

FIG. 5 is a flowchart illustrating a procedure of the check candidate presentation processing performed when the control unit 101 according to the present exemplary embodiment executes the information processing program according to the present exemplary embodiment.

In step S501, the control unit 101 reads the distress data from the distress data table corresponding to the inspection target specified by the user via the input device 105 from among a plurality of distress data tables stored in the storage device 104.

In step S502, the control unit 101 acquires coordinate data on end points of cracks from the distress data read in step S501.

In step S503, the control unit 101 moves a candidate determination region of a predetermined size (area) in the coordinate space including coordinates of all pieces of distress data to search for positions of candidate determination regions that include coordinates of end points of two or more cracks. The control unit 101 determines a check candidate region based on the position of the candidate determination region that includes coordinates of end points of two or more cracks in the coordinate space. When the control unit 101 finds a plurality of positions of the candidate determination regions that include coordinates of end points of two or more cracks in the coordinate space, the control unit 101 determines a check candidate region for each of the positions of the candidate determination regions.

In the present exemplary embodiment, the sizes and the shapes of a candidate determination region and a check candidate region are the same as each other. However, at least one of the size and the shape may be different between the candidate determination region and the check candidate region.

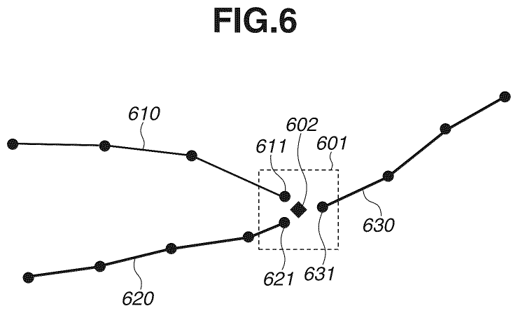

FIG. 6 is a diagram illustrating processing of determining a check candidate region using search processing with the candidate determination region by the control unit 101 in step S503 of FIG. 5.

The control unit 101 moves a candidate determination region 601 in the coordinate space including coordinates of all pieces of distress data to search for a position where the candidate determination region 601 includes coordinates of two or more end points. When the control unit 101 finds the position where the candidate determination region 601 includes coordinates of two or more end points, the control unit 101 calculates the center coordinates of the coordinates of the end points in the candidate determination region 601 to determine a check candidate region with the center coordinates as the center of the region. FIG. 6 illustrates an example where an end point 611 of a distress 610, an end point 621 of a distress 620, and an end point 631 of a distress 630 are included in the candidate determination region 601. When the control unit 101 finds a position where the candidate determination region 601 includes the coordinates of three end points 611 to 631, the control unit 101 determines the check candidate region with a center coordinate 602 of the coordinates of those three end points as the center of the region. In FIG. 6, a square region having a predetermined size (area) is illustrated as an example of the candidate determination region. However, the candidate determination region is not limited thereto, and may be, for example, a circular region having a predetermined radius.

The candidate determination region 601 may include candidates of more end points. In this case, for example, the control unit 101 may calculate the center coordinates for each set of three adjacent end points to determine a check candidate region using the mean of the plurality of center coordinates as the region center.

After step S503 described above, the control unit 101 repeatedly performs processing in steps S504 to S507.

In step S505 in the repetitive processing, the control unit 101 calculates a check difficulty of the check candidate region that is a target of the check difficulty calculation. The control unit 101 acquires the number of cracks, and attributes of the cracks, such as widths and directions, from the distress data on the cracks with the end points included in the check candidate region to calculate a check difficulty of the check candidate region based on the number and the attributes of the cracks. The control unit 101 assigns a score indicating the check difficulty to the check candidate region.

For example, the more cracks with the end points included in a check candidate region are, the more difficult it is for the user to determine (check) whether correction is needed and which cracks should be connected. Thus, the control unit 101 increases the check difficulty of the check candidate region as the number of cracks with the end points included in the check candidate region increases. As an example, the control unit 101 calculates the number of cracks based on the number of defect IDs of the cracks with the end points included in a check candidate region to calculate a check difficulty with a weight corresponding to the number of cracks. A wight value of ten times, for example, can be used as an example of the weight corresponding to the number of cracks.

For example, when a plurality of cracks with similar widths (thicknesses) among a plurality of cracks with the end points included in a check candidate region, it is also considered to be difficult for the user to determine (check) whether correction is needed or which cracks should be connected.

Thus, the control unit 101 may acquire the number of cracks with similar widths among the cracks with the end points included in the check candidate region to determine a check difficulty based on the number of cracks with similar widths. In other words, the control unit 101 acquires a check difficulty using the number of cracks with similar widths, as well as the number of cracks with the end points included in the check candidate region.

In this case, the control unit determines whether the cracks are similar in width, for example, based on a classification according to the size of the width of a crack. For example, the control unit 101 classifies a plurality of cracks with the end points included in the confirmation candidate region into a plurality of ranks based on the size of their widths. The control unit 101 determines the cracks with the widths in the same rank to be highly similar, while the cracks classified into different ranks are considered to be non-similar cracks with low similarity.

The control unit 101 calculates a check difficulty by applying a weight based on the number of cracks whose end points are included in a check candidate region, along with the number of cracks that have high similarity in width. As the weight value based on the number of cracks with high similarity in width, for example, a value of seven times can be used. In other words, the control unit 101 acquires the check difficulty of a check candidate region by applying a weight based on the number of cracks with high similarity in width, as well as the weight based on the number of cracks described above.

The example is described where the check difficulty is determined based on the number of cracks with the end points included in a check candidate region and the number of cracks with high similarity in width. However, determination of the check difficulty is not limited thereto. For example, the control unit 101 can determine the check difficulty using the number of cracks with high similarity in width alone.

Further, for example, with a plurality of cracks with similar directions of cracks among the cracks with the end points included in a check candidate region, it is also considered to be difficult for the user to determine (check) whether corrections are needed or which cracks should be connected. Thus, the control unit 101 can acquire a check difficulty based on the number of cracks with similar directions of cracks among the cracks with the end points included in the confirmation candidate region. In this case, the control unit 101 calculates a crack direction, for example, based on an angle calculated from the coordinate values of the starting point and the end point of the distress data registered in the vertex coordinate list 205, or either the mean, the median, or the mode of angles of line segments constituting the crack distresses. Further, the control unit 101 determines whether the cracks are similar in direction based on an angle between the crack directions. For example, the control unit 101 determines cracks with angles between their directions less than a threshold to be cracks with high similarity, while cracks with angles between their directions greater than or equal to the threshold to be cracks with low similarity. As an example, a threshold of 30 degrees is used for an angle between the crack directions. In this case, when the angle between the crack directions is less than 30 degrees, the control unit 101 determines that the similarity of the crack directions is high, whereas when the angle is greater than or equal to 30 degrees, the control unit 101 determines that the cracks are non-similar cracks with low similarity in the crack direction. Further, the control unit 101 may use, as the similarity of the crack direction, for example, similarity of angles of the line segments forming the cracks with the end points included in a check candidate region.

Further, the control unit 101 calculates the check difficulty by applying weights corresponding to the number of cracks with high similarity in direction, as well as the number of cracks with the end points included in a check candidate region. As a weight value based on the number of cracks with high similarity in direction, for example, five times can be used. In other words, the control unit 101 acquires the check difficulty of the check candidate region by applying weights corresponding to the number of cracks with high similarity in direction, as well as the above-described weight corresponding to the number of cracks.

The example is described where the check difficulty of a check candidate region is determined based on the number of cracks with the end points included in the check candidate region and the number of cracks with high similarity in direction. However, determination of the check difficulty of a check candidate region is not limited thereto. For example, the control unit 101 can determine the check difficulty of the check candidate region using the number of cracks with high similarity in direction alone. For example, the control unit 101 can determine the check difficulty of the check candidate region using both the number of cracks with high similarity in direction and the number of cracks with high similarity in width described above. Further, the control unit 101 can determine the check difficulty of the confirmation candidate region using the number of cracks with high similarity in direction and the number of cracks with high similarity in width, as well as the number of cracks with the end points included in the confirmation candidate region.

As described above, the control unit 101 according to the present exemplary embodiment increases the check difficulty of a check candidate region as the number of cracks with the end points included in the check candidate region increases, and as the similarity of attributes, such as the width and the direction, of the cracks with the end points included in the check candidate region increases.

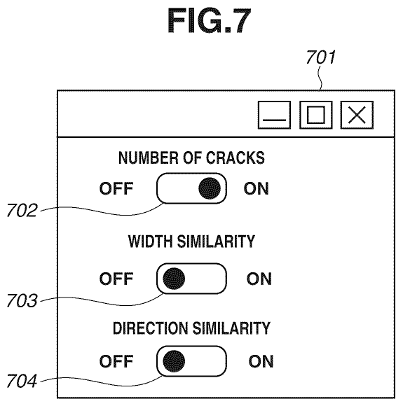

Further, the control unit 101 can determine whether to use the number of cracks with the end points included in a check candidate region, the width similarity of the cracks, and the direction similarity of the cracks in determining the check difficulty of the check candidate region based on an instruction from the user. FIG. 7 is a diagram illustrating an example of a rule setting GUI screen 701 on which the user makes a setting indicating whether to use the number of cracks, the width similarity of the cracks, and the direction similarity of the cracks in acquiring the check difficulty of a check candidate region.

In the rule setting GUI screen 701 illustrated in FIG. 7, a number-of-cracks use switch 702 is a toggle switch with which the user instructs on and off settings indicating whether to use the number of cracks for acquiring the check difficulty of a check candidate region. A width similarity use switch 703 is a toggle switch with which the user instructs on and off settings indicating whether to use the width similarity of the cracks in acquiring the check difficulty of the check candidate region. A direction similarity use switch 704 is a toggle switch with which the user instructs on and off settings indicating whether to use the direction similarity of the cracks for acquiring the check difficulty of the check candidate region. The control unit 101 determines whether to use the number of cracks, the width similarity, and the direction similarity in calculating the check difficulty based on the on and off settings of the switches 702 to 704 in the rule setting GUI screen 701 illustrated in FIG. 7.

The description returns to the flowchart in FIG. 5.

In step S506 in the repetitive processing, the control unit 101 classifies the check candidate region as the hard rank 404, the middle rank 405, or the easy rank 406 illustrated in FIG. 4A based on the score of the check difficulty assigned to the check candidate region in step S505. Further, the control unit 101 highlights the check candidate regions in the result display region 401 illustrated in FIG. 4A based on the classification of the ranks. The control unit 101 may highlight a check candidate region based on the score of the check difficulty alone greater than or equal to a predetermined threshold, and may not highlight the check candidate regions based on scores less than or equal to the predetermined threshold.

The control unit 101 registers the information on each of the check candidate regions acquired by the repetitive processing in steps S504 to S507 in a check candidate region table. The check candidate region table is stored in, for example, the storage device 104.

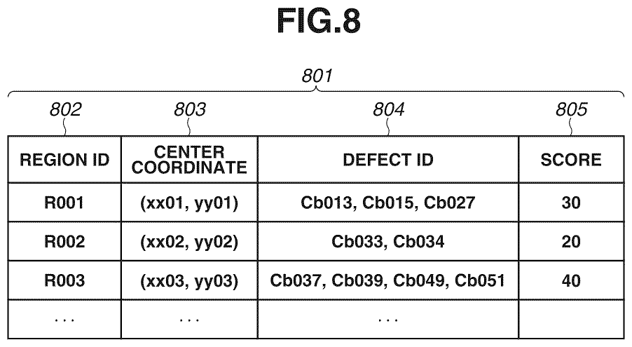

FIG. 8 is a table illustrating an example of a check candidate region table 801. In the check candidate region table 801, a region ID 802 is identification information uniquely assigned to each check candidate region detected in step S503. A center coordinate 803 shows center coordinates of the check candidate regions.

A defect ID 804 is a list of the defect IDs of the crack distresses with the end points included in the check candidate regions. A score 805 indicates the check difficulties acquired for the check candidate regions in step S505.

When the processing in steps S504 to S507 is completely performed on all of the check candidate regions extracted from the coordinate space in step S503, the processing proceeds to step S508.

In step S508, the control unit 101 determines whether the user performs a region specification operation to specify any of the region IDs in the check region list 402 illustrated in FIGS. 4A and 4B. If the user performs the region specification operation to specify any of the region IDs (YES in step S508), the processing proceeds to step S509. In contrast, if the user does not perform the region specification operation (NO in step S508), the processing returns to step S508 unless it is determined in step S510 described below that an instruction is input to end the check candidate presentation processing.

In step S509, the control unit 101 enlarges and displays an image portion including the check candidate region corresponding to the region ID specified by the user in the result display region 401. FIG. 4B illustrates an example where a region having the region ID of R011 in the check region list 402 is specified by the user, and an image portion including the check candidate region corresponding to the region ID is displayed as an enlarged display image 422.

In step S510, the control unit 101 determines whether the instruction to end the check candidate presentation processing is input by the user. If the end instruction is input (YES in step S510), the processing in the flowchart of FIG. 5 ends. If the end instruction is not input (NO in step S510), the processing returns to step S508.

As described above, the information processing apparatus 100 according to the present exemplary embodiment searches for check candidate regions where the end points of cracks gather within a predetermined size range based on detection results of crack distress to calculate and display the check difficulty for each of the check candidate regions. In other words, according to the present exemplary embodiment, areas of disconnected crack distress that may be falsely detected or may be undetected on the image are presented as check candidate regions to the user. This enables the user to easily check the crack distress. Further, according to the present exemplary embodiment, the check difficulty is calculated based on the number and the attributes of cracks with the end points included in a check candidate region, and the check candidate region is highlighted based on the check difficulty. This makes it possible to present the regions to be checked in the coordinate space to the user.

According to the present exemplary embodiment, a distress portion requiring correction and editing can be presented to the user.

A second exemplary embodiment will now be described. In the first exemplary embodiment, the example is described where a check candidate region including two or more end points of distresses is searched for, and the check difficulty is acquired based on at least any of the number and the attributes of distresses with the end points included in the check candidate region. In the present exemplary embodiment, an example will be described where a user attribute is used to adjust a check candidate region to be presented (displayed) to the user. The configuration and the processing of the information processing apparatus 100 according to the present exemplary embodiment are substantially similar to those of the information processing apparatus 100 according to the above-described exemplary embodiment. Thus, the illustration and the redundant description will be omitted.

In the present exemplary embodiment, the user attribute refers to a level of experience in performing a distress check task, i.e., indicates whether the user is a skilled expert with extensive experience or a beginner with little experience in such a task. The attribute of the experience indicating whether the user is an expert or a beginner can be set by the user themselves or by another user, or can be set by the control unit 101 based on the number of times or the amount of time the user performed the distress check task in the past.

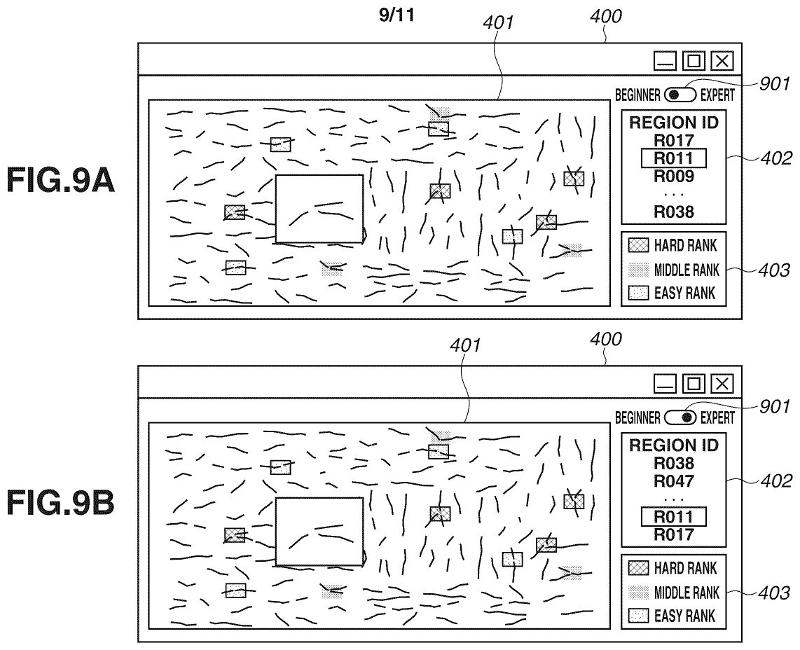

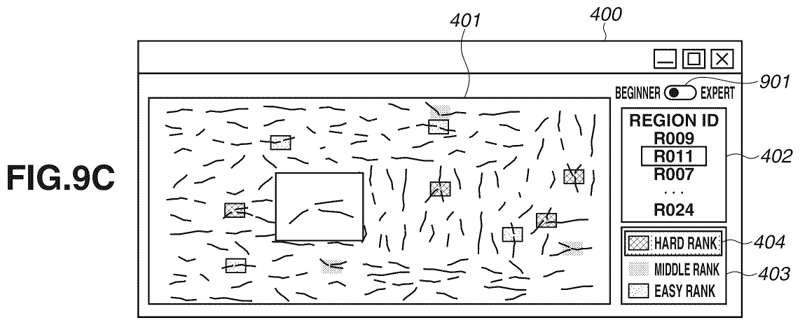

FIGS. 9A to 9C are diagrams each illustrating an example of a distress check GUI screen 400 according to the present exemplary embodiment. In the GUI screen 400 illustrated in FIGS. 9A to 9C, a user attribute switch 901 for setting the user attribute is added to the example of the GUI screen 400 illustrated in FIGS. 4A and 4B described above. The user attribute switch 901 is a toggle switch with which the user who checks a distress on an image using the information processing apparatus 100 according to the present exemplary embodiment inputs the attribute of a beginner or an expert.

FIG. 9A illustrates the GUI screen 400 in a state where the user attribute switch 901 is set to the beginner. When the user attribute switch 901 is set to the beginner, the control unit 101 changes the display order of the region IDs of the check candidate regions in the check region list 402 to ascending order of the region IDs with low check difficulty. This enables the user as a beginner to check whether to correct the distress in check candidate regions starting from a check candidate region with the lowest check difficulty.

FIG. 9B illustrates the GUI screen 400 in a state where the user attribute switch 901 is set to the expert. When the user attribute switch 901 is set to the expert, the control unit 101 changes the display order of the region IDs of the check candidate regions in the check region list 402 to descending order of the region IDs with high check difficulty. This enables the user as an expert to check whether to correct the distress in check candidate regions starting preferentially from a check candidate region that is difficult to be determined by the beginner.

In FIG. 9A described above, when the user attribute switch 901 is set to the beginner, the region IDs of check candidate regions are displayed in the check region list 402 in the ascending order of the check difficulty. However, the region IDs of check candidate regions with high check difficulty may not be displayed. When the user attribute switch 901 is set to the beginner, the control unit 101 hides, for example, the regions IDs of the check candidate regions each having a score of the check difficulty greater than or equal to a predetermined threshold. FIG. 9C illustrates an example of the GUI screen 400 when the user is a beginner and the region IDs of the check candidate regions each having a score of the check difficulty greater than or equal to the threshold are hidden in the check region list 402. In the check region list 402 illustrated in FIG. 9C, the regions IDs of the check candidate regions each having a high score of the check difficulty, such as R038 and R047 that are displayed in the check region list 402 illustrated in FIG. 9B, are hidden. In this case, the control unit 101 can hide the hard rank 404 of the legend indicating high check difficulty in the candidate legend display region 403. This allows the user to check whether to correct a distress without being affected by the check candidate regions with high check difficulty that cause uncertainty in the user's decision-making.

A third exemplary embodiment will now be described. In the present exemplary embodiment, an example will be described where determination of correction on a distress with the end points included in a check candidate region can be suspended based on the user attribute. The configuration and the processing of the information processing apparatus 100 according to the present exemplary embodiment are substantially similar to those of the information processing apparatus 100 according to the above-described exemplary embodiments. Thus, the illustration and the redundant description will be omitted.

For example, if the user is a beginner, the user may not be able to determine whether to correct a distress in the displayed check candidate regions. Thus, in the information processing apparatus 100 according to the present exemplary embodiment, the distress and the check candidate regions can be shared with the information processing apparatus of another user who is an expert, allowing the expert user to check the check candidate regions.

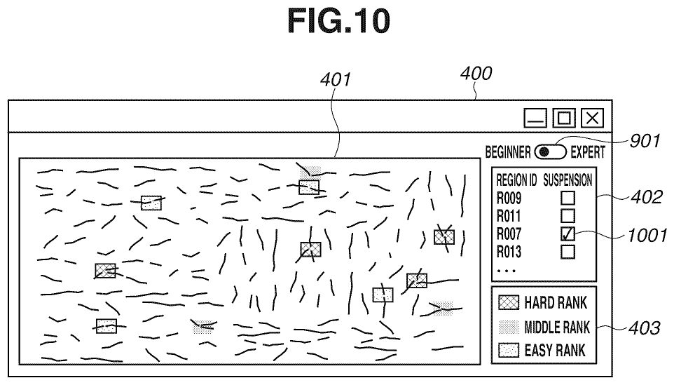

FIG. 10 illustrates an example of the distress check GUI screen 400 according to the present exemplary embodiment, and a determination suspension checkbox 1001 is added to the check region list 402. If the user as a beginner is not able to determine whether to correct a crack distress in check candidate regions, the user can check the determination suspension checkbox 1001 corresponding to the region ID of the check candidate region. When the determination suspension checkbox 1001 is checked, the control unit 101 sends a notification to the information processing apparatus of another user that shares the check candidate regions and the distress with the beginner user's information processing apparatus, requesting a check of the check candidate region with the specified region ID.

As described above, according to the present exemplary embodiment, a user as a beginner with little experience can request another user, such as an expert, to make a decision on whether to correct a distress in a check candidate region.

### Other Exemplary Embodiments

In the above-described exemplary embodiments, the examples are described where the information processing apparatus 100 used by the user performs all processing relating to presentation of the distress check candidates. However, the processing may be shared with another computer apparatus, such as a server client system. For example, a server may perform the processing of calculating a check difficulty, and the client-side information processing apparatus may perform presentation (display) to the user using the check difficulty calculated by the server. The number of information processing apparatuses on the client side is not limited to one, and a plurality of information processing apparatuses can be used. This allows the check difficulty calculated by the server to be accessed from each of the user's information processing apparatuses on the client side, enabling each user to check a distress in check candidate regions.

In each of the above-described exemplary embodiments, a crack is described as an example of a distress. However, a distress is not limited to a crack. For example, various types of distress that occurs on surfaces of structures, such as delamination, flaking, efflorescence, cold joints, rock pocket (honeycombing), surface air bubbles, sand streaks, and rust stains, can be extracted as candidate regions where the end points gather within a predetermined range. For each type of distress, difficulties of the candidate regions can then be calculated and each candidate region can be displayed based on the calculated difficulty.

The present disclosure can be implemented by supplying programs that carry out one or more functions of the above-described exemplary embodiments to a system or an apparatus via a network or a storage medium, and causing one or more processors in a computer of the system or the apparatus to read and execute the programs. Further, the present disclosure can be implemented by a circuit that carries out one or more functions (e.g., Application Specific Integrated Circuit (ASIC)).

The above-described exemplary embodiments are merely examples for implementing the present disclosure, and the technical scope of the present disclosure is not to be interpreted as being limited by the above-described exemplary embodiments. In other words, the present disclosure can be implemented in various forms without departing from the technical idea or the main features of the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-102843. which was filed on June 26. 2024 and which is hereby incorporated by reference herein in its entirety.

What is claimed is:

1. An information processing apparatus comprising:
one or more memories storing instructions; and
one or more processors configured to, upon executing the instructions:
detect, as a candidate region, a region within a predetermined size range including two or more end points of distresses from a captured image of an inspection target;
acquire a difficulty in a case where a user determines whether to perform a predetermined task on the distresses having the end points included in the candidate region; and
display the candidate region based on the difficulty.

2. The information processing apparatus according to claim 1, wherein the difficulty is acquired based on at least a number of the distresses having the two or more end points included in the candidate region, a width similarity of the distresses having the two or more end points included in the candidate region, or a direction similarity of the distresses having the two or more end points included in the candidate region.

3. The information processing apparatus according to claim 2, wherein the difficulty is higher as the number of distresses having the two or more end points included in the candidate region increases.

4. The information processing apparatus according to claim 2, wherein the difficulty is higher as the width similarity of the distresses having the two or more end points included in the candidate region is higher.

5. The information processing apparatus according to claim 2, wherein the difficulty is higher as the direction similarity of the distresses having the two or more end points included in the candidate region is higher.

6. The information processing apparatus according to claim 2, wherein the one or more processors, upon executing the instructions, acquire directions of the distresses based on any of a mean, a median, and a mode of angles of line segments forming the distresses having the two or more end points included in the candidate region.

7. The information processing apparatus according to claim 1, wherein the one or more processors, upon executing the instructions, highlight the candidate region based on the difficulty.

8. The information processing apparatus according to claim 1, wherein the one or more processors, upon executing the instructions, determine the candidate region to be displayed based on the difficulty.

9. The information processing apparatus according to claim 1, wherein the one or more processors, upon executing the instructions, change a display order of the candidate region based on the difficulty and a user attribute.

10. The information processing apparatus according to claim 1, wherein the one or more processors, upon executing the instructions, display or hide the candidate region based on the difficulty and a user attribute.

11. The information processing apparatus according to claim 9, wherein the one or more processors, upon executing the instructions, issue a predetermined notification to another information processing apparatus based on the difficulty and the user attribute.

12. The information processing apparatus according to claim 11, wherein the one or more processors, upon executing the instructions, issue the predetermined notification for requesting determination as to whether to perform the predetermined task on the distresses having the two or more end points included in the candidate region, from the other information processing apparatus sharing the distresses and the candidate region.

13. The information processing apparatus according to claim 9, wherein the user attribute is information set based on experience of the user in the predetermined task.

14. The information processing apparatus according to claim 1, wherein the candidate region is detected by moving the region of the predetermined size range in the captured image of the inspection target, and searching for a position where the region within the predetermined size range includes the two or more end points.

15. The information processing apparatus according to claim 1, wherein the candidate region is a region having center coordinates of the two or more end points included in the region within the predetermined size range as a center.

16. The information processing apparatus according to claim 1, wherein, in a case where the region within the predetermined size range includes a plurality of center coordinates of the two or more end points, the candidate region is a region having coordinates of a mean of the plurality of center coordinates as a center.

17. The information processing apparatus according to claim 1, wherein the predetermined distresses are cracks in a concrete structure as the inspection target.

18. An information processing method comprising:
detecting, as a candidate region, a region within a predetermined size range including two or more end points of distresses from a captured image of an inspection target;
acquiring a difficulty in a case where a user determines whether to perform a predetermined task on the distresses having the two or more end points included in the candidate region; and
displaying the candidate region based on the difficulty.

19. A non-transitory computer-readable storage medium storing computer-executable instructions for causing a computer that has a display to execute a method of controlling an information processing system, the method comprising:
detecting, as a candidate region, a region within a predetermined size range including two or more end points of distresses from a captured image of an inspection target;
acquiring a difficulty in a case where a user determines whether to perform a predetermined task on the distresses having the two or more end points included in the candidate region; and
displaying the candidate region based on the difficulty.
